(19) United States
(12) Patent Application Publication
(10) Pub. No.: US 2013/0314778 A1
(43) Pub. Date: Nov. 28, 2013

(54) MICROSCOPE

(71) Applicant: CANON KABUSHIKI KAISHA, Tokyo (JP)

(72) Inventors: Hirofumi Fujii, Toyono-gun (JP); Michio Yanagisawa, Utsunomiya-shi (JP); Yuji Sudoh, Hadano-shi (JP)

(73) Assignee: CANON KABUSHIKI KAISHA, Tokyo (JP)

(21) Appl. No.: 13/898,362

(22) Filed: May 20, 2013

(30) Foreign Application Priority Data
May 23, 2012 (JP) 2012-117483

(51) Int. Cl. G02B 21/28

(52) U.S. Cl. CPC G02B 21/28
USPC 359/391

(57) ABSTRACT

A microscope includes a stage that holds an object, an objective optical system that forms an image of the object, a light receiving unit that receives the image of the object, and a driving unit that moves the stage between a first position where the image of the object is taken and a second position that is different from the first position. The stage includes a nozzle from which a gas is ejected. The nozzle is provided such that the gas is ejected from the nozzle toward the objective optical system when the stage is at the second position.

### BACKGROUND OF THE INVENTION

1. Field of the Invention

The present application relates to a microscope and is suitable for a microscope intended for pathological diagnosis, for example.

2. Description of the Related Art

In recent methods, doctors make pathological diagnosis on the basis of images of inspection objects (preparations), including samples such as cells and tissues, acquired through microscopes. In a microscope, an inspection object stage that holds an inspection object is movable by an actuator between a position at which the inspection object is exchanged with another and a position at which an image of the inspection object is taken. Hence, images of a plurality of inspection objects can be taken successively.

To help doctors make correct diagnosis, images of inspection objects are desired to be of high definition and high quality. Accordingly, an objective optical system included in a microscope is desired to have a large numerical aperture (NA). In a case where an image is to be taken through an objective optical system having a large NA, however, if the distance between the inspection object and the objective optical system is large, the diameter of the objective optical system needs to be increased. Hence, in a case where a microscope includes an objective optical system having a large NA, the inspection object and the objective optical system are desired to be positioned close to each other.

To acquire an image of an inspection object that is of high definition and high quality, the objective optical system of the microscope needs to constantly exhibit high performance. If the temperature of the objective optical system changes, the optical performance of the objective optical system may change. Hence, the temperature of the objective optical system is desired to be controlled with high accuracy. Nevertheless, the actuator that moves the inspection object stage generates heat, raising the temperature of the inspection object stage to a level higher than the ambient temperature. As a result, in a configuration in which the inspection object and the objective optical system are positioned close to each other, the heat that is transferred to the objective optical system from the inspection object stage whose temperature has risen may significantly affect the optical performance of the objective optical system.

Possible solutions for the above problem include a method in which the temperature of the objective optical system is controlled by adjusting the temperature of the objective optical system. Specifically, Japanese Patent Laid-Open No. 2003-7586 discloses a configuration in which an exposure apparatus including a projection lens is enclosed by a chamber, and a gas having an adjusted temperature is supplied into the chamber, whereby the temperature of the exposure apparatus as a whole is adjusted. Japanese Patent Laid-Open No. 2011-233573 discloses another configuration in which a nozzle is provided in a chamber enclosing a projection lens, and a gas is ejected from the nozzle aiming at the projection lens.

As described above, a microscope requires a mechanism that adjusts the temperature of its objective optical system. Meanwhile, as a reduction in the installation space, the size of such a temperature adjusting mechanism is desired to be minimized so that the size of an apparatus as a whole including the microscope is reduced. In the configuration disclosed by Japanese Patent Laid-Open No. 2003-7586, the entirety of the projection lens is enclosed by a cover, into which a large amount of temperature adjusted gas needs to be supplied. If the configuration disclosed by Japanese Patent Laid-Open No. 2003-7586 is applied to a microscope, the size of an apparatus as a whole including the microscope may be difficult to reduce.

In a microscope to which the configuration disclosed by Japanese Patent Laid-Open No. 2011-233573 is applied, even if it is attempted to reduce the flow rate of the temperature adjusted gas that is supplied from the nozzle, it is difficult to position the nozzle close to the objective optical system in a configuration in which the inspection object and the objective optical system are positioned close to each other.

### SUMMARY OF THE INVENTION

The present disclosure provides a microscope in which the temperature of an objective optical system is adjustable with high accuracy while the increase in the size of an apparatus including the microscope is suppressed.

According to one aspect of the present disclosure, a microscope is provided. The microscope includes a stage that holds an object, an objective optical system that forms an image of the object, a light receiving unit that receives the image of the object, and a driving unit that moves the stage between a first position where the image of the object is taken and a second position that is different from the first position. The stage includes a nozzle from which a gas is ejected. The nozzle is provided such that the gas is ejected from the nozzle toward the objective optical system when the stage is at the second position.

Further features of the present invention will become apparent from the following description of exemplary embodiments with reference to the attached drawings.

### BRIEF DESCRIPTION OF THE DRAWINGS

FIG. 1 schematically illustrates a microscope according to an embodiment disclosed herein.

FIG. 2 illustrates how to exchange an inspection object with another.

FIG. 3 illustrates different positions of a nozzle.

FIG. 4 is a graph illustrating changes in the temperature of an objective optical system versus time.

FIG. 5 illustrates possible positions of thermometers.

### DESCRIPTION OF THE EMBODIMENTS

An embodiment of the present disclosure will now be described in detail with reference to the attached drawings.

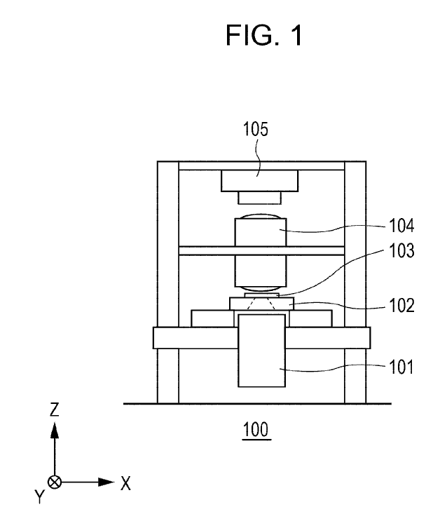

FIG. 1 schematically illustrates a microscope 100 according to an embodiment of the present disclosure. The microscope 100 according to the embodiment includes an illumination system 101 that illuminates an inspection area of an inspection object 103, an inspection object stage 102 that holds the inspection object 103, an objective optical system 104 that forms an image of the inspection area of the inspection object 103, and a light receiving unit 105 that receives the image of the inspection area of the inspection object 103. The inspection object stage 102 includes an actuator (a driving unit, not illustrated) and is capable of moving the inspection object 103 in horizontal directions (XY directions) while holding the inspection object 103. Using the objective optical system 104 as a magnification system, a magnified image of the inspection object 103 is acquired. To acquire a high-resolution image of the inspection object 103, the objective optical system 104 has a large numerical aperture (NA), and the inspection object 103 and the objective optical system 104 are positioned close to each other. The objective optical system 104 may be, for example, a system such as a catadioptric system that forms an intermediate image by using a Mangin mirror or the like.

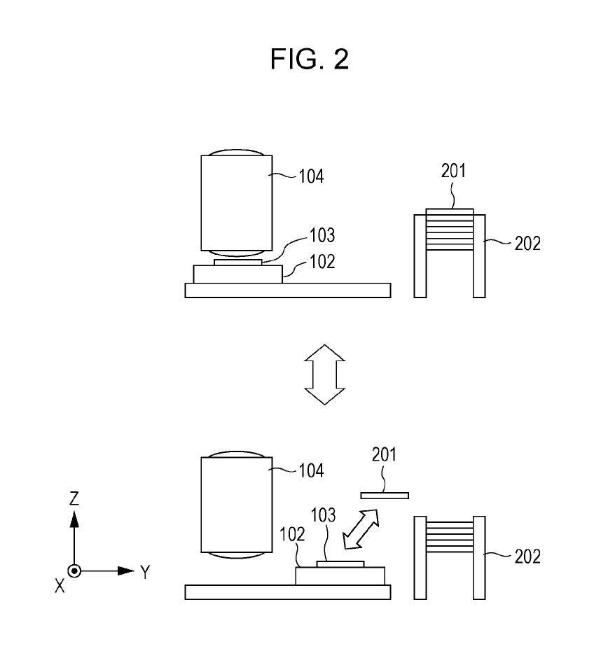

FIG. 2 illustrates how to exchange the inspection object 103 with another. In the microscope 100, the inspection object 103 and the objective optical system 104 are positioned close to each other. Therefore, it is difficult to exchange the inspection object 103 with another inspection object 201 when the inspection object stage 102 is at an image taking position (a first position) as illustrated in the upper part of FIG. 2. Hence, in the embodiment, the inspection object 103 whose image has been taken is exchanged with another inspection object 201 after the inspection object stage 102 is moved to an exchanging position as illustrated in the lower part of FIG. 2. The image taking position referred to herein is a position of the inspection object stage 102 when the inspection area of the inspection object 103 is at the object position of the objective optical system 104.

Specifically, after the inspection object stage 102 is moved to the exchanging position, the inspection object 103 is removed from the inspection object stage 102 and is moved to an inspection object stocker 202. Then, an inspection object 201 that is to be inspected next is picked up from a plurality of inspection objects that are stored in the inspection object stocker 202, and the inspection object 201 is placed on the inspection object stage 102. By moving the inspection object stage 102 between the image taking position and the exchanging position, inspection objects are exchangeable smoothly. Thus, images of a plurality of inspection objects can be taken successively.

To pick up an inspection object from the inspection object stage 102 or the inspection object stocker 202, a mechanism that mechanically nips the inspection object or a mechanism such as a vacuum chuck that utilizes the effect of pressure may be employed, for example. To reduce the time taken to pick up the inspection object, a plurality of such pickup mechanisms may be provided so that inspection objects can be picked up from the inspection object stage 102 and the inspection object stocker 202 simultaneously. To move the inspection object that has been picked up, any of a rotational movement mechanism, a vertical movement mechanism, a multi-degree-of-freedom articulated mechanism, a linear movement mechanism, and the like may be employed. The inspection object stocker 202, the pickup mechanism, and the movement mechanism in combination form an exchanging unit.

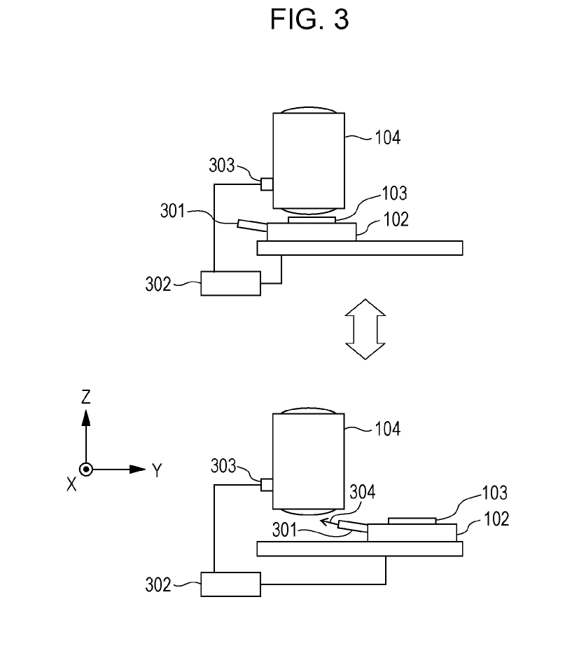

FIG. 3 illustrates a mechanism that supplies a gas 304 whose temperature has been adjusted (hereinafter also referred to as temperature adjusted gas) toward the objective optical system 104. The upper part of FIG. 3 illustrates a state where the inspection object stage 102 is at the image taking position. The lower part of FIG. 3 illustrates a state where the inspection object stage 102 is at a position (a second position) that is different from the image taking position.

As illustrated in FIG. 3, the inspection object stage 102 has a nozzle 301. The nozzle 301 is connected to a temperature-adjusted-gas generator (not illustrated) with a tube or the like and is capable of ejecting the temperature adjusted gas 304 whose temperature has been adjusted by the temperature-adjusted-gas generator. The nozzle 301 does not come into contact with the objective optical system 104 even if the inspection object stage 102 is moved.

A process of supplying the temperature adjusted gas 304 from the nozzle 301 will now be described specifically. Referring to the upper part of FIG. 3, after an image of the inspection object 103 is taken at the image taking position, the inspection object stage 102 is moved to the second position as illustrated in the lower part of FIG. 3. At the second position, the temperature adjusted gas 304 whose temperature has been adjusted by the temperature-adjusted-gas generator is ejected from the nozzle 301 through the tube, whereby the temperature of the objective optical system 104 is adjusted. The nozzle 301 is provided such that the temperature adjusted gas 304 is ejected toward the objective optical system 104 when the inspection object stage 102 is at the second position. Hence, the flow rate or the duration of ejection of the temperature adjusted gas 304 can be reduced even in a configuration in which the inspection object 103 and the objective optical system 104 are provided close to each other, and the temperature of the objective optical system 104 is adjustable with high accuracy while the increase in the size of an apparatus as a whole including the microscope 100 is suppressed.

The second position may be set to such a position that the efficiency in the adjustment of the temperature of the objective optical system 104 using the nozzle 301 is maximized (for example, a position where the distance between an ejection port of the nozzle 301 and the objective optical system 104 becomes smallest). If the second position is set at the same position as the exchanging position, the temperature of the objective optical system 104 becomes adjustable while the inspection object 103 is exchanged with another. Consequently, the throughput of the apparatus is improved.

A control unit 302 may also be provided so that the temperature adjusted gas 304 ejected from the nozzle 301 is controllable. Gas controlling operations according to the embodiment include controlling of at least one of the following: switching of the nozzle 301 of whether to eject the gas 304, to suck air, or to stop the gas 304; the flow rate (pressure) of the gas 304; the duration of ejection of the gas 304; and the temperature of the gas 304. For example, the control unit 302, which controls the temperature-adjusted-gas generator to supply the gas 304 whose temperature has been adjusted to a certain level, may also control the temperature of the gas 304. Specifically, if a thermometer 303 is provided on the objective optical system 104, the control unit 302 can control, in accordance with the temperature of the objective optical system 104, the temperature of the temperature adjusted gas 304 to be supplied from the temperature-adjusted-gas generator. In this manner, the temperature of the objective optical system 104 is adjustable more accurately. Alternatively, the thermometer 303 may be provided to another position so that the temperature of the temperature adjusted gas 304 is controllable in accordance with the ambient temperature, the temperature of the inspection object stage 102, or the like. In FIG. 3, the control unit 302 is provided on the outside of and is electrically connected to the temperature-adjusted-gas generator. Alternatively, the control unit 302 may be included in the temperature-adjusted-gas generator.

A valve (not illustrated) that is capable of adjusting the flow rate (pressure) of the temperature adjusted gas 304 may also be provided to one of the nozzle 301 or the tube. The opening and closing of the valve may be controlled by the control unit 302 such that the temperature adjusted gas 304 is ejected only when the inspection object stage 102 is moved to the second position. Moreover, the temperature of the objective optical system 104 may be adjusted by controlling the valve through the control unit 302 and thus adjusting the amount or duration of ejection of the temperature adjusted gas 304, instead of controlling the temperature of the gas 304 in the temperature-adjusted-gas generator.

Many particles of dust are present in the microscope 100. Particles of dust are taken into or generated in the microscope 100 during the use of the microscope 100, specifically, when the microscope 100 is assembled or the inspection object 103 is exchanged with another, or when the inspection object stage 102 is moved in the microscope 100. Hence, if there are strong air currents around the objective optical system 104 or the inspection object 103 when the temperature adjusted gas 304 is supplied toward the objective optical system 104, such particles of dust may be blown upward and adhere to the objective optical system 104 or the inspection object 103, preventing the acquisition of a high-definition, high-quality image of the inspection object 103.

With the nozzle 301 described above, however, the temperature adjusted gas 304 is ejected toward the objective optical system 104 after the inspection object stage 102 is moved from the image taking position to the second position. Hence, in the microscope 100 according to the embodiment, the flow rate of the temperature adjusted gas 304 to be ejected toward the objective optical system 104 can be reduced while particles of dust that may adhere to the objective optical system 104 or the inspection object 103 are reduced.

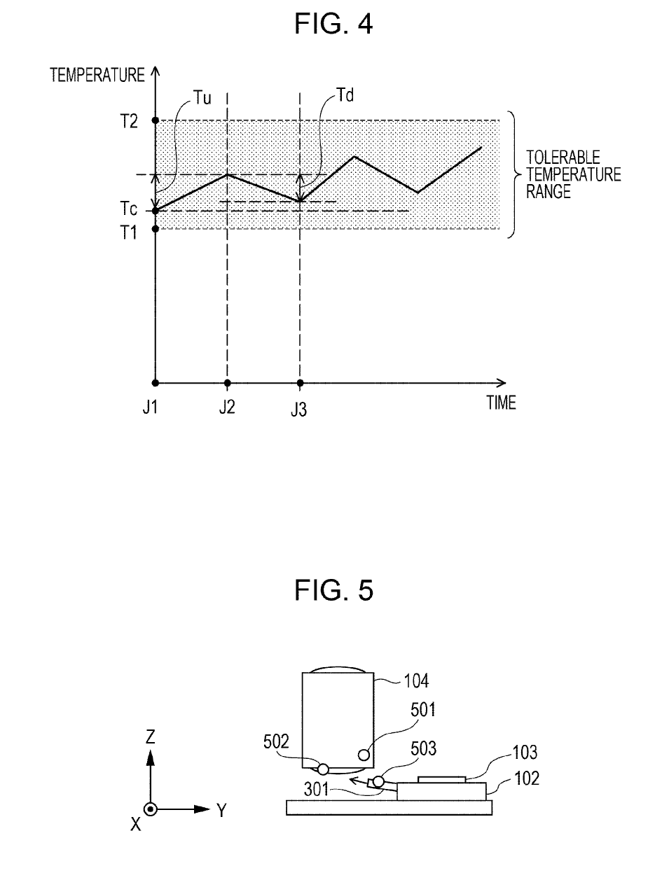

How to control the temperature of the objective optical system 104 will now be described. FIG. 4 is a graph illustrating changes in the temperature of the objective optical system 104 versus time. The horizontal axis of the graph represents time. The vertical axis of the graph represents the temperature of the objective optical system 104. The hatched zone in the graph represents a tolerable temperature range (from T1 to T2) in which the objective optical system 104 exhibits a predetermined level of performance. In this case, the temperature of the objective optical system 104 rises when the inspection object stage 102 is at the image taking position, whereas the temperature of the objective optical system 104 drops when the inspection object stage 102 is moved to the second position. The graph is an exemplary history of changes in the temperature of the objective optical system 104.

The graph in FIG. 4 will be described specifically. Let the temperature of the objective optical system 104 at the moment the inspection object stage 102 is moved to the image taking position be Tc (the temperature Tc needs to be within the tolerable temperature range). Suppose that the temperature of the objective optical system 104 rises by an amount Tu when an image taking operation is performed over a time period from J1 to J2, and the temperature of the objective optical system 104 drops by an amount Td when the inspection object stage 102 is moved to the second position and the temperature of the objective optical system 104 is adjusted over a time period from J2 to J3. The amount of temperature rise Tu varies with how long the inspection object stage 102 is at the image taking position or the type of driving sequence for the inspection object stage 102. The amount of temperature drop Td can be controlled by means of adjusting the temperature, the flow rate, or the duration of ejection of the temperature adjusted gas 304 ejected from the nozzle 301 (how long the inspection object stage 102 is at the second position).

The amount of temperature rise Tu depends on the inspection area of the inspection object 103, conditions for the image taking operation, and so forth and is therefore difficult to control. Hence, the amount of temperature drop Td is controlled such that the temperature of the objective optical system 104 falls within the tolerable temperature range. To adjust the temperature of the objective optical system 104 that has risen from the temperature Tc by the amount of temperature rise Tu to be within the tolerable temperature range by lowering the temperature of the objective optical system 104 by the amount of temperature drop Td, a condition of T1<Tc+Tu−Td<T2 needs to be satisfied. That is, the amount of temperature drop Td is to be set so as to satisfy a condition of Tc−T2+Tu<Td<Tc−T1+Tu. In the embodiment, the amount of temperature drop Td may be increased by increasing the flow rate of the temperature adjusted gas 304, lowering the temperature of the temperature adjusted gas 304, or increasing the duration of ejection of the temperature adjusted gas 304.

The amount of temperature drop Td may be set such that the temperature of the objective optical system 104 is expressed in the form (T1+T2)/2 at which the objective optical system 104 exhibits the best performance. That is, the amount of temperature drop Td may be set to a value expressed in the form Td=Tc+Tu−(T1+T2)/2. The temperature of the objective optical system 104 rises while the inspection object stage 102 is at the image taking position. Therefore, the amount of temperature drop Td may alternatively be set to a value expressed in the form Td=Tc+Tu−T1 so that the temperature of the objective optical system 104 becomes T1 immediately before an image taking operation is started.

To correctly and quickly perform the above-described temperature adjusting operation, a thermometer may be provided directly on the objective optical system 104 so that the temperature of the objective optical system 104 can be measured. In this manner, a required amount of temperature drop Td is calculable from the information on the measured temperature of the objective optical system 104. The calculated amount of temperature drop Td may be fed back to the calculation of, for example, the temperature, the flow rate, or the duration of ejection of the temperature adjusted gas 304 (or how long the inspection object stage 102 is at the second position).

To correctly estimate the amount of temperature drop Td, the temperature, the flow rate, the duration of ejection, and so forth of the temperature adjusted gas 304 to be ejected from the nozzle 301 may be measured. In such measurements, another thermometer may be provided on the nozzle 301 so that the temperature of the temperature adjusted gas 304 can be measured directly. In this manner, the temperature of the objective optical system 104 may be lowered by the required amount of temperature drop Td by controlling the temperature of the temperature adjusted gas 304 to be ejected from the nozzle 301.

FIG. 5 illustrates possible positions of thermometers that may be provided. A position 501 is defined on a surface of a lens barrel portion of the objective optical system 104, a position 502 is defined on a lens portion of the objective optical system 104, and a position 503 is defined on the nozzle 301. In the microscope 100 according to the embodiment, the objective optical system 104 is fixed. Hence, the positions 501 and 502 are fixed. If a thermometer is provided at the position 501 or 502, the position of the thermometer is fixed. Therefore, the path along which an output wire that is connected to the thermometer is provided can be determined easily.

A thermometer for the objective optical system 104 may be provided at either of the positions 501 and 502. The part of the objective optical system 104 where the temperature should be controlled is the lens portion corresponding to the position 502. Therefore, the temperature at the position 502 is to be measured. If a thermometer is provided directly on the lens portion, however, light from the inspection area of the inspection object 103 may be blocked by the thermometer. Therefore, the position 502 of a thermometer is to be defined at such a position of the lens portion that the light is not blocked by the thermometer (for example, an edge of the lens portion).

To summarize, in the microscope 100 according to the embodiment in which the inspection object 103 and the objective optical system 104 are positioned close to each other, the temperature of the objective optical system 104 is adjustable with high accuracy while the increase in the size of the apparatus as a whole is suppressed.

### Modifications

While an exemplary embodiment of the present disclosure has been described above, the present disclosure is not limited thereto. Various modifications and changes can be made to the above embodiment within the scope of the present disclosure.

For example, the microscope 100 according to the above embodiment may also include a measuring unit that is capable of acquiring, before an image taking operation is performed on the inspection object 103, conditions for the image taking operation such as the focus position on the inspection object 103 and the area of the inspection object 103 to be imaged. In a case where the measuring unit is provided at a position (measuring position) that is different from the image taking position, conditions for taking an image of the inspection object 103 can be acquired by moving the inspection object stage 102 holding the inspection object 103 to the measuring position.

In such a case, if the measuring position is set between the exchanging position and the image taking position, the measurement and the image taking operation for an inspection object 201 that is picked up from the inspection object stocker 202 can be performed successively. Furthermore, if the second position is set to the same position as the measuring position, the temperature of the objective optical system 104 can be adjusted while the measurement of the inspection object 103 is performed.

Furthermore, the nozzle 301 may be configured to be capable of sucking air so that the temperature adjusting operation or the dust removing operation can be performed by suction of air. In such a configuration, the control unit 302 controls the nozzle 301 to eject the temperature adjusted gas 304 or to suck air, whereby the temperature adjusting operation and the dust removing operation for the objective optical system 104 may be switched therebetween.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-117483, filed May 23, 2012, which is hereby incorporated by reference herein in its entirety.

What is claimed is:

1. A microscope comprising:
a stage that holds an object;
an objective optical system that forms an image of the object;
a light receiving unit that receives the image of the object; and
a driving unit that moves the stage between a first position where the image of the object is taken and a second position that is different from the first position,
wherein the stage includes a nozzle from which a gas is ejected, and
wherein the nozzle is provided such that the gas is ejected from the nozzle toward the objective optical system when the stage is at the second position.

2. The microscope according to claim 1, further comprising a control unit that controls the gas ejected from the nozzle.

3. The microscope according to claim 2, wherein the control unit controls at least one of switching of the nozzle to eject the gas, to suck air, or to stop the gas; the flow rate of the gas; the duration of ejection of the gas; and the temperature of the gas.

4. The microscope according to claim 2, wherein the control unit operates so the gas is ejected from the nozzle only when the stage is at the second position.

5. The microscope according to claim 1, further comprising:
an exchanging unit that exchanges the object held by the stage with another,
wherein, when the stage is at the second position, the exchanging unit exchanges the object with another.

6. The microscope according to claim 1, further comprising:
a measuring unit that acquires conditions for taking an image of the object,
wherein, when the stage is at the second position, the measuring unit acquires the conditions for taking an image of the object.

7. The microscope according to claim 2, further comprising:
a thermometer,
wherein the control unit controls the gas on the basis of temperature information that is acquired via the thermometer.

8. The microscope according to claim 7, wherein the thermometer acquires information on the temperature of the objective optical system.

9. The microscope according to claim 8, further comprising:
a thermometer that acquires information regarding the temperature of the nozzle,
wherein the control unit controls the gas on the basis of the information on the temperatures of the objective optical system and the nozzle.

10. The microscope according to claim 1, wherein an ejection port of the nozzle and the objective optical system are closest to each other when the stage is at the second position.
